(19) United States
(12) Patent Application Publication
(10) Pub. No.: US 2012/0083314 A1
(43) Pub. Date: Apr. 5, 2012

(54) Multimedia Telecommunication Apparatus With Motion Tracking

(76) Inventors: Hock M. Ng, Westfield, NJ (US); Edward L. Sutter, Fanwood, NJ (US)

(21) Appl. No.: 13/029,326

(22) Filed: Feb. 17, 2011

Related U.S. Application Data
(60) Provisional application No. 61/404,268, filed on Sep. 30, 2010.

(51) Int. Cl. H04W 88/02

(52) U.S. Cl. 455/557

(57) ABSTRACT

A docking system for a personal communication terminal includes a base and a motorized mount joining the dock to the base and configured to rotate the dock about a vertical axis in response to a pan signal and about a horizontal axis in response to a tilt signal. The docking system further comprises a sensor array to produce signals indicative of the location of a user, a processor to convert the sensor output signals to tracking signals, and a controller to convert the tracking signals to pan and tilt signals, thereby to aim a camera.

### CLAIM FOR PRIORITY

Priority is claimed from U.S. Provisional Application Ser. No. 61/404,268, filed Sep. 30, 2010 by H. M. Ng and E. L. Sutter under the title, “Multimedia Telecommunication Apparatus with Motion Tracking.”

### CROSS-REFERENCE TO RELATED APPLICATIONS

Some of the subject matter of this application is related to the subject matter of the commonly owned U.S. patent application Ser. No. 12/770,991, filed Apr. 30, 2010 by E. L. Sutter under the title, “Method and Apparatus for Two-Way Multimedia Communications.”.

Some of the subject matter of this application is related to the subject matter of the commonly owned U.S. patent application Ser. No. 12/759,823, filed Apr. 14, 2010 by H. M. Ng under the title, “Immersive Viewer, A Method of Providing Scenes on a Display and an Immersive Viewing System.”.

### FIELD OF THE INVENTION

The invention relates to user terminals for telecommunication.

### ART BACKGROUND

Next generation handheld mobile devices (such as “smartphones” and tablet computers) will be increasingly used for person-to-person video calls. It is already common for advanced cellular handsets (referred to here as “smartphones”) to include video cameras, and models will be increasingly available that are equipped with front-facing cameras, i.e. with at least one camera situated on the same side of the handset as the display.

If front-facing cameras are used on the local handset, the remote party is able to view the local party's face during a telephone conversation. However, the local user might find it undesirable to manually hold the handset during the entire course of a video call. Devices such as docking stations are available that facilitate hands-free operation. Thus, the user could place the handset in a docking station during part, or all, of the call.

However, conventional docking stations are fixed or at best are manually adjustable between static positions. Therefore, a user of such devices who wishes to remain visible to the remote party must remain within a limited spatial volume between manual adjustments of the field of view of the camera.

Thus, there is a need to loosen the spatial constraints on the parties to such a call.

### SUMMARY OF THE INVENTION

A docking system is provided for a smartphone or tablet computer. (By “smartphone” is meant any wireless handset that is equipped with one or more video cameras and is capable of sending and receiving video signals.) The docking system is mechanized so that under microprocessor control, it can pan and/or tilt the view seen by a camera mounted in the docking system. The camera may be built into the smartphone or tablet computer. As a consequence, the local user can conduct a hands-free video call while providing the remote party with a continuous view of the local user's face through the smartphone's camera.

The tracking control may be provided by a feedback system. In the feedback system, an input such as face detection is used to continuously compute new sets of pan/tilt angles representative of the potentially changing position of the user.

Accordingly, an embodiment includes a dock for a personal wireless communication terminal, a base, and a motorized mount joining the dock to the base. The motorized mount is configured to rotate the dock about a vertical axis in response to a pan signal and about a horizontal axis in response to a tilt signal. A sensor array including at least two spatially separated microphones is configured to produce output signals indicative of the location of a user. A processor is configured to process the sensor output signals, thereby to at least partially convert them to tracking signals. A controller is electrically connected to the motorized mount and is configured to convert the tracking signals to the pan and tilt signals used to aim the camera. The camera is permanently or removeably attached to the dock.

In another embodiment, a method is performed using a personal wireless communication terminal emplaced in a dock. The method includes steps of transmitting a local user's voice from the terminal, transmitting—from the terminal—a video signal produced by a camera, and controlling—from the terminal—pan and tilt orientations of the camera. The controlling step includes receiving tracking signals indicative of a desired motion of the camera from at least one of: a local sensor array, a local manual control device, and a remote manual control device. The controlling step further includes processing the tracking signals to produce pan and tilt signals, and directing the pan and tilt signals to a motorized mount for the dock.

In another embodiment, a system includes two or more personal wireless communication terminals that are situated at respective geographically separated locations and are interconnected by a communication network. At least one of the terminals is emplaced in a docking apparatus of the kind described above. At least one of the locations includes a stereophonic loudspeaker array arranged to reproduce user speech detected by the sensor array of the docking apparatus. At least one of the terminals is situated at a location that includes a stereophonic loudspeaker array and is configured to transmit tracking signals in response to local user input. More specifically, the tracking signals are transmitted to at least one docked terminal at a remote location for aiming a camera situated at the remote location. The system further includes a server configured to select at most one speaker at a time for video display by the terminals.

### BRIEF DESCRIPTION OF THE DRAWING

FIGS. 1 and 2 are partially schematic perspective drawings of a docking system according to the invention in exemplary embodiments.

FIGS. 3 and 4 are functional block diagrams illustrating the interrelationships among various functionalities of the docking station and the docked smartphone or other personal communication terminal.

FIG. 5 is a schematic diagram showing several users engaged in a conference call over a network.

### DETAILED DESCRIPTION

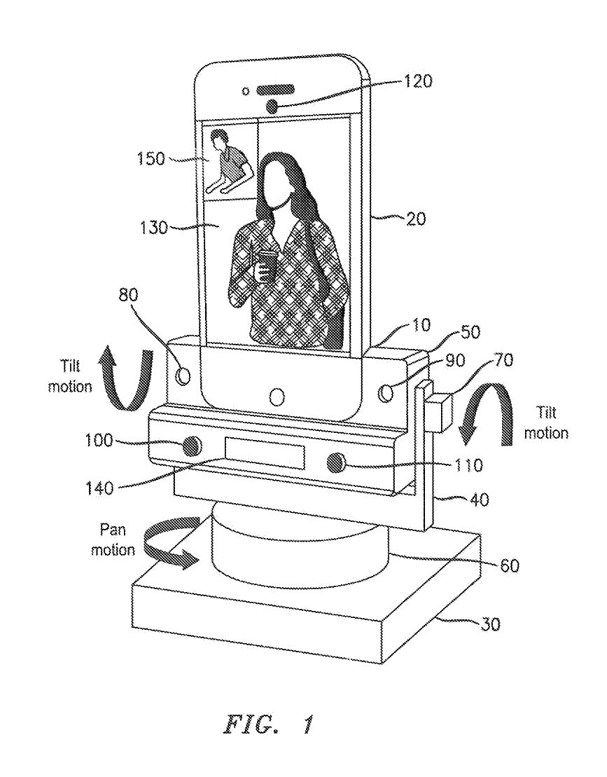

With reference to FIG. 1, an exemplary docking system includes dock 10 for personal wireless communication terminal 20, shown in the figure as a smartphone for illustration only and not by way of limitation. Docks into which a smartphone or other personal communication device can be removeably emplaced with convenience are well known and commercially available, and need not be described here in detail.

Dock 10 is supported from below by base 30, to which it is attached by a motorized Mount. The motorized mount includes member 40 which is rotatable about a vertical axis giving rise to “pan” movement, and member 50, which is rotatable about a horizontal axis, giving rise to “tilt” movement. Members 40 and 50 are driven, respectively, by pan servomotor 60 and tilt servomotor 70. The pan and tilt servomotors are respectively driven by pan and tilt signals, which will be discussed below. It will be understood that the mechanical arrangement described here is merely illustrative and not meant to be limiting.

At least two spatially separated microphones 80 and 90 are provided. The separation between microphones 80 and 90 is desirably great enough that when stimulated by the voice of a local user, the microphones are able to provide a stereophonic audio signal that has enough directionality to at least partially indicate a direction from which the user's voice is emanating. As shown in the figure, the microphones are mounted so as to be subject to the same pan and tilt motions as the docked terminal. Such an arrangement facilitates a feedback arrangement in which the rotational orientation of the dock is varied until audio feedback indicates that the dock is aimed directly at the user. If the microphone array has directional sensitivity only with respect to the pan direction but not with respect to the tilt direction, it may be sufficient if the microphones are mounted so as to be susceptible only to pan movements but not to tilt movements.

The microphones are of course also useful for sensing the local user's voice so that it can be transmitted to the opposite party at the far end, or to multiple remote parties in a conference call. Advantageously, a stereophonic audio signal is sent to the remote parties for playback by an array of two or more stereophonic loudspeakers, or by stereo headphones worn by the remote parties. In that manner, the remote parties can perceive directionality of the local user's voice. As will be discussed below, some embodiments of our system will permit a remote party to respond to the perception of directionality by manually steering the local dock to keep it pointed at the local speaker, or even to point it at a second local speaker who has begun to speak.

Additional sensors may provide further help in determining the position of the local user. For example, a thermal sensor 100, such as a passive infrared detector, may be used to estimate the position of the local user relative to the angular position of the docking system by sensing the local user's body heat. This is useful, e.g., for adjusting the pan position of the camera. As a further example, an ultrasonic sensor 110 may provide active ultrasonic tracking of the user's movements.

Camera 120 is provided to capture a video image of the local user for transmission to the remote parties. Advantageously, the video image of the local user is also used to help determine the position of the local user and thus to help aim the dock. For such a purpose, the video image is subjected to image processing as described below. As shown in the figure, personal wireless communication terminal 20 is equipped with a front-facing camera, which is identified as camera 120 in the figure. If terminal 20 does not have a front-facing camera, camera 120 may alternatively be a camera built into the docking system in such a way that it is subject to the same pan and tilt movements as terminal 20.

As shown in the figure, local playback of signals from remote parties is facilitated by video display screen 130 and loudspeaker 140. Although only a single loudspeaker is shown in the figure, it may be advantageous to provide an array of two or more stereophonic speakers, as explained above. Inset 150 in the displayed view represents a view of the local user as captured by camera 120 and displayed in the form of a picture-in-picture.

Although not shown in the figures, it will in at least some cases be advantageous to provide an audio output connection for stereo headphones, to impart to the local user an enhanced sense of the direction of the sound source, i.e., of the direction of the voice of the remote user who is currently speaking.

Raw output from the microphones and other sensors is processed to provide tracking signals. The tracking signals, in turn, are processed to provide input signals to a controller (not shown in the figure) electrically connected to the motorized mount. The controller converts the tracking signals to the pan and tilt signals used to aim the camera.

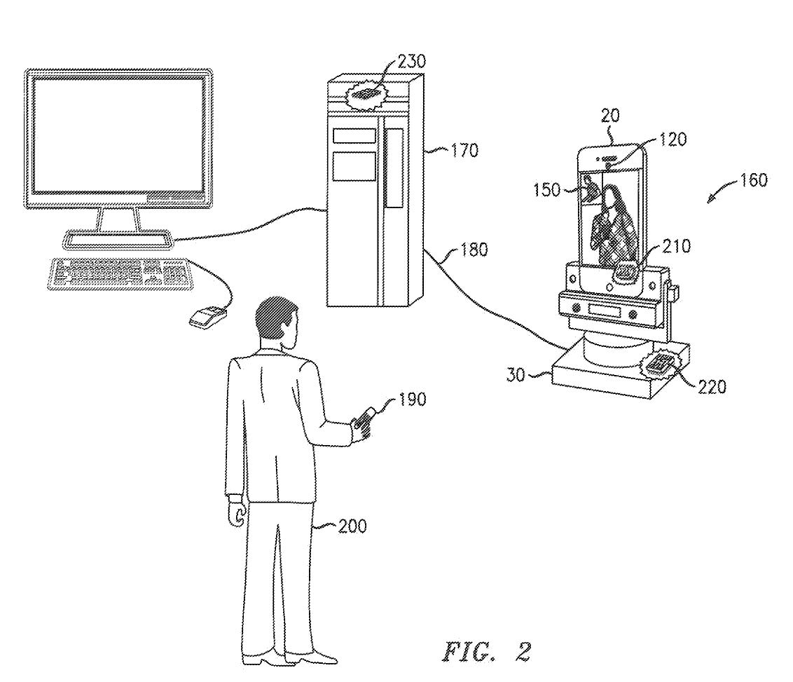

Another view of the docking system is shown in FIG. 2, where like reference numerals are used to indicate certain features that are common with FIG. 1. As shown in the figure, docking system is electrically connected to personal computer 170, e.g. through USB bus 180. The docking system is also in wireless communication with hand-held remote control unit (RCU) 190, which is shown being manipulated by local user 200. RCU 190 provides a convenient means for the local user to manually adjust the direction in which camera 120 is pointed. If, for example, user 200 wishes to override the automatic tracking mechanism, he may manually adjust the camera direction while using picture-in-picture 150 for visual feedback.

As mentioned above and discussed further below, the operation of the docking system involves several levels of signal processing. In addition to the processing of raw signal output from the sensors, there is processing of video signals from camera 120 for tracking the local user as well as for transmission. Further types of signal processing will become apparent from the discussion below.

Signal processing may take place within one, two, three, or even more devices. Accordingly and by way of illustration, three microprocessors are shown in cutaway views in FIG. 2. Terminal 20 includes microprocessor 210, docking system 160 includes microprocessor 220, and personal computer 170 includes microprocessor 230. If processor 210 within the user terminal is sufficiently powerful, it can be used for most of the processing, although it will generally be useful for processor 220 within the docking system to condition the raw output signals from the sensors, to facilitate their further processing. Alternatively, applications running on processor 220 and/or on processor 230 within the personal computer can share the processing load with the user terminal.

Thus, for example, a portion of the control software may run on a microprocessor of relatively low computational power in the smartphone or in the docking station, while a further portion of the software runs on a more powerful processor in the external computer. Such an arrangement relaxes the demand for computational power in the smartphone or the docking station.

In one particular scenario, camera 120 is built into docking system 160, and not into user terminal 20. Processor 220 performs all of the image processing of the video signal from camera 120 that is needed to produce image-based tracking signals, and also forwards the video signal to terminal 20 for transmission to the remote party or parties. In such a scenario, the docking system is able to track the movements of the local user without participation from the user terminal.

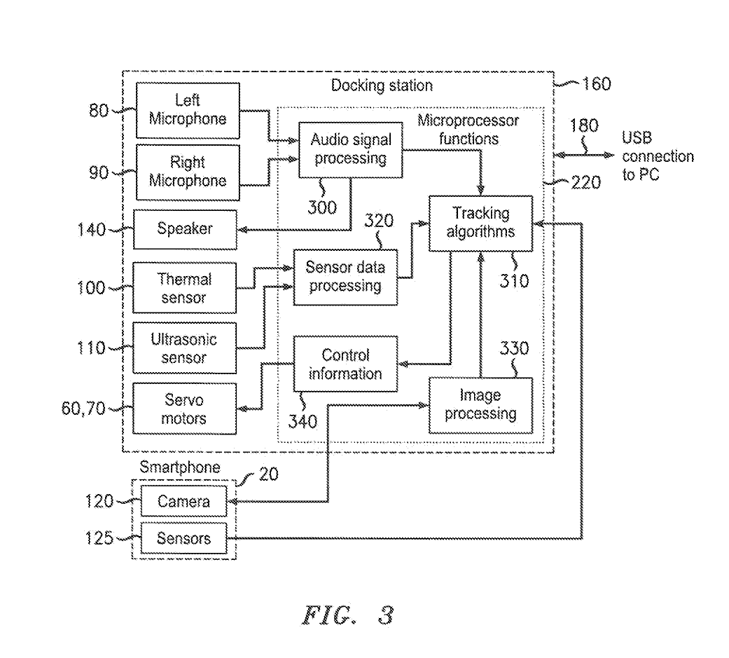

Reference is now made to the functional block diagram of FIG. 3, where elements common with FIGS. 1 and 2 are designated by like reference numerals. In the figure, various processing blocks, to be described below, are shown as executed within microprocessor 220 within the docking system. As explained above, such an arrangement is merely illustrative, and not meant to exclude other possible arrangements in which the processing is shared with microprocessors in the user terminal and/or in an attached personal computer.

As seen in the figure, audio signals from microphones 80 and 90 are processed in block 300, resulting in a drive signal for local loudspeaker 140 and further resulting in signals, indicative of the direction from which the local user is speaking, for further processing by the tracking algorithms at block 310. The output signals from further sensors, such as thermal sensor 100 and ultrasonic sensor 110 are processed at block 320 to produce signals indicative of user location or user movement for further processing at block 310. Additional sensors 125 may be built into user terminal 20. After conditioning by a processor within the user terminal, the output from sensors 125 may also be processed at block 310. As seen in the figure, the video output from camera 120 is subjected to image processing at block 330, resulting in signals indicative of user location for further processing at block 310.

At block 310, the various signals indicative of user location or user movement are processed by the tracking algorithms, resulting in tracking signals that are output to block 340. At block 340, the tracking signals are processed to provide the pan and tilt signals that are directed to servomotors 60 and 70.

Video tracking algorithms using face-detection, for use e.g. in block 330, are well known and need not be described here in detail. Similarly, various tracking algorithms useful e.g. for the processing that takes place in blocks 300, 310, 320, and 340 are well known and need not be described here in detail.

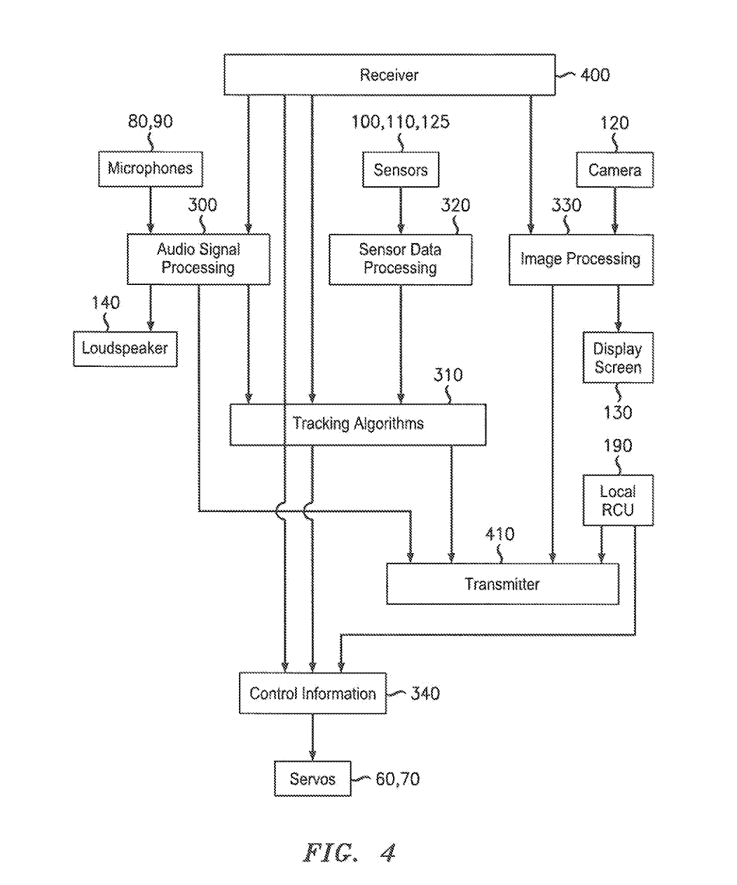

As explained above, the pan and tilt control signals may be generated by block 340 in an autonomous mode in which they are responsive to local sensing. They may alternatively be generated in a local-manual mode in response to the local user's manipulation of an RCU or, e.g., a touch screen. Such a mode is conveniently described with reference to FIG. 4, which summarizes the functional blocks of FIG. 3 and adds blocks for the receiver 400 and transmitter 410 incorporated in the user terminal. Figure elements common with FIGS. 1-3 are designated by like reference numerals. In the local-manual mode, the party at the local end may use, e.g., RCU 190 to override the autonomous control and provide a specifically selected view to the party or parties at the remote end, aided by visual feedback of the view seen by the remote parties and displayed in the picture-in-picture portion of display screen 130.

Yet another possible mode is a remote-manual mode, in which the party or parties at the remote end of the call may transmit directional information intended, for example, to keep the party at the local end in view of the camera at the local end. With further reference to FIG. 4, it will be seen that incoming signals received by receiver 400 may include the directional signals from the remote parties, which are directed e.g. to block 310 for processing by the tracking algorithms, and thence to block 340 for generation of corresponding pan and tilt signals to control the servomotors.

As shown in FIG. 4, receiver 400 also receives audio signals from the remote party or parties, which are directed to audio signal processing block 300 and thence to loudspeaker 140, and it also receives video signals from the remote party or parties, which are directed to image processing block 330 and thence to display screen 130. As likewise shown in FIG. 4, the audio output from the local microphones, after processing at block 300, is transmitted by transmitter 410 to the remote party or parties, and the video output from camera 120, after processing at block 330, is also transmitted by transmitter 410 to the remote party or parties.

Connectivity between or among the parties to a call may be provided by any communication medium that is capable of simultaneously carrying the audio, video, and data (i.e. control) components of the call. Cellular-to-cellular calls will be possible using an advanced wireless network standard such as LTE. In another approach, connectivity is over the Internet. In such a case, the smartphone or other user terminal may connect to an Internet portal using, e.g., its WiFi capability. In yet another approach, the docking system may be connected to the Internet through a local appliance such as a laptop or personal computer.

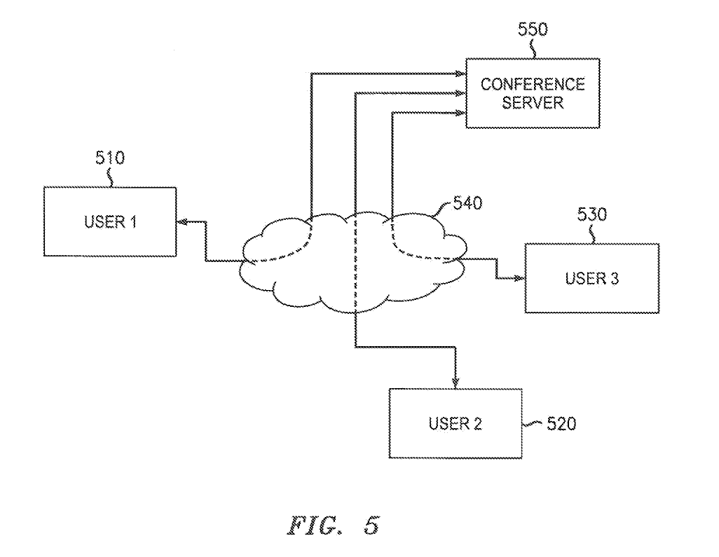

Thus, for example, FIG. 5 shows three users 510, 520, 530 at geographically separated locations carrying on a conversation over network 540. As noted above, network 540 may be, by way of example and without limitation, the Internet or an LTE network. Various users may engaged in one-to-one communication, or a conference server 550 may be included as a central node connected to the individual parties, as shown in FIG. 5. At least one of the users will be understood as using a docked personal communication terminal as described above. Other users may be using similar devices, or other communication devices such as standalone smartphones, laptop or desktop personal computers, tablet computers, or the like.

### Example Use Cases

In one scenario, a user engages in a one-on-one call. For example, Adam is preparing dinner in the kitchen of his home. He discovers that he is short a few ingredients for his recipe, but realizes that his wife Eve is at that moment at the) supermarket. Adam docks his smartphone on the motion-tracking docking system and initiates a video call to Eve. Adam can conduct the video call hands-free while still maintaining eye-contact with Eve, because the docking system can pan and tilt and follow Adam around with face detection or another tracking algorithm. If Eve notices that Adam has begun speaking to an unseen third party, she can enter the remote-manual mode by invoking an appropriate application running on her smartphone. In the remote-manual mode, Eve manually directs the docking system until the third party comes into her view.

In a second scenario, a multi-party video conference call has been arranged. Eve arrives at her office and docks her smartphone in preparation for the video conference call. All the other remote participants have similar smartphone docks. Due to the limited screen real estate on a “smartphone” only the person who is currently speaking may be displayed on the screens of the other parties.

In the case of a multi-party conference, each party can call in to a central server, such as server 550 of FIG. 5, where the intelligence resides for determining which participant is speaking, and therefore which participant should be displayed to the other participants on the call. Typically, the audio component of the call will proceed uninterrupted while the video view is being negotiated and/or switched. In at least some cases, an appropriate such server will be a multipoint control unit (MCU) configured to operate with H.323 and SIP protocols.

What is claimed is:

1. Apparatus comprising:
a dock for a personal wireless communication terminal;
a base;
a motorized mount joining the dock to the base and configured to rotate the dock about a vertical axis in response to a pan signal and about a horizontal axis in response to a tilt signal;
a sensor array comprising at least two spatially separated microphones and configured to produce output signals indicative of the location of a user;
a processor configured to process the sensor output signals, thereby to at least partially convert the sensor output signals to tracking signals; and
a controller electrically connected to the motorized mount and configured to convert the tracking signals to pan and tilt signals, thereby to aim a camera that is permanently or removeably attached to the dock.

2. The apparatus of claim 1, further comprising a personal wireless communication terminal emplaced in the dock.

3. The apparatus of claim 2, wherein the camera is part of the personal wireless communication terminal.

4. The apparatus of claim 2, wherein the personal wireless communication terminal is configured to receive tracking signals from a remote location for conversion to pan and tilt signals.

5. The apparatus of claim 2, wherein the conversion of sensor output signals to tracking signals is done, at least in part, by a processor within the personal wireless communication terminal.

6. The apparatus of claim 2, wherein the controller is implemented, at least in part, by a processor within the personal wireless communication terminal.

7. The apparatus of claim 1, wherein the sensor array further comprises a thermal sensor and an ultrasonic sensor.

8. A method performed using a personal wireless communication terminal emplaced in a dock, comprising:
transmitting a local user's voice from the terminal;
transmitting, from the terminal, a video signal produced by a camera; and
controlling, from the terminal, pan and tilt orientations of the camera, wherein the controlling step comprises:
receiving tracking signals indicative of a desired motion of the camera from at least one of: a local sensor array, a local manual control device, and a remote manual control device;
processing the tracking signals to produce pan and tilt signals; and
directing the pan and tilt signals to a motorized mount for the dock.

9. The method of claim 8, wherein the step of receiving tracking signals comprises receiving output signals from the sensor array and processing the sensor output signals to determine desired rotational displacements for the camera.

10. The method of claim 8, further comprising displaying, on a screen of the personal communication terminal, a video image of a remote user.

11. The method of claim 10, further comprising displaying, on the screen, an inset image representing the video signal being transmitted by the camera.

12. The method of claim 8, further comprising switching the transmitted video signal on and off in response to signaling from a remote location indicating respectively that the local user is or is not a currently designated speaker.

13. A system comprising two or more personal wireless communication terminals that are situated at respective geographically separated locations and are interconnected by a communication network, wherein:
one or more of the personal wireless communication terminals are emplaced in respective docking apparatuses as recited in claim 1;
at least one of the geographically separated locations includes a stereophonic loudspeaker array arranged to reproduce user speech detected by the sensor array of said docking apparatus;
at least one of the personal wireless communication terminals: (a) is situated at a location that includes a stereophonic loudspeaker array, and (b) is configured so that in response to local user input, it will transmit tracking signals to at least one personal wireless communication terminal emplaced in a remote one of the docking apparatuses in order to aim a remote camera; and
the system further comprises a server configured to select at most one speaker at a time for video display by the personal wireless communication terminals.
